(19) United States
(12) Patent Application Publication
(10) Pub. No.: US 2007/0031224 A1
(43) Pub. Date: Feb. 8, 2007

(54) Trailer locking and positioning system

(76) Inventor: David W. Lutz, Carlisle, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/401,476

(22) Filed: Apr. 10, 2006

Related U.S. Application Data
(60) Provisional application No. 60/670,928, filed on Apr. 13, 2005.

(51) Int. Cl. B60P 1/00

(52) U.S. Cl. 414/440

(57) ABSTRACT

A trailer locking and positioning system includes at least one locking device. The locking device includes means for locking a trailer and means for laterally and/or vertically aligning the trailer.

### CROSS REFERENCE TO RELATED APPLICATION

This application claims the benefits of U.S. Provisional Patent Application Ser. No. 60/670,928, filed Apr. 13, 2005, which application is herein incorporated by reference in its entirety.

### BACKGROUND OF THE INVENTION

1. Field of the Invention

This invention relates generally to a locking and positioning system for a trailer and, more particularly, to a locking and positioning system that does not damage the rear bumper of the trailer.

2. Technical Considerations

Locking devices are known to lock a conventional trailer in place at a location for loading and unloading the trailer (hereinafter generally referred to as “loading dock”). Typically, these known locking devices are center-mounted below the loading dock door. These known locking devices have one end attached to the loading dock and another end that attaches to the bumper of the trailer. For long haul applications in which the trailer is infrequently connected to these known locking devices, these known devices function adequately. However, for shorter routes where there is a higher frequency of the locking devices being attached to and detached from the trailer bumper, these known locking devices can damage the trailer bumper due to the frequent attachment and unattachment. Additionally, these known locking devices typically do not have sufficient structural strength to prevent the trailer from being inadvertently driven away from the loading dock. In such a situation, either the locking device itself would break or, more probably, the trailer bumper would be ripped from the trailer. Moreover, these known locking devices do not provide any guiding and/or aligning functions to align the trailer into a desired position and/or a desired height with respect to the loading dock.

Therefore, it would be desirable to provide a trailer locking and positioning system that reduces or eliminates at least some of the problems discussed above with respect to known locking devices. For example, it would be advantageous to provide a system that not only locks the trailer in place for loading and unloading but also aligns (horizontally and/or vertically) the trailer with the loading dock to facilitate loading and unloading of the trailer.

### SUMMARY OF THE INVENTION

A trailer locking and positioning system of the invention comprises at least one locking device. The locking device can include means for locking a trailer and means for laterally and/or vertically aligning the trailer at a location.

A particular trailer locking and positioning system of the invention comprises a skid connectable with a trailer, the skid including a locking portion having a locking face. The system also includes a locking device having a ramp leading to a positioning platform, at least one guide segment, and a pin moveable between a locked position and an unlocked position. The system also includes an outer operating station comprising a plug, a cord, and a receptacle. The plug is configured to releasably engage the receptacle. An inner operating station comprises controls for operating one or more systems at a loading dock and/or on a trailer.

### BRIEF DESCRIPTION OF THE DRAWINGS

The invention will be described with reference to the following drawing figures wherein like reference numbers identify like parts throughout.

FIG. 1 is a perspective view of a locking device of the invention;

FIG. 2 is a perspective view of an exterior loading dock incorporating the locking and positioning system of the invention;

FIG. 3 is a front view of the loading dock of FIG. 2;

FIG. 4 is a perspective, interior view of the loading dock of FIG. 2;

FIG. 5 is a rear view of the loading dock of FIG. 4;

FIG. 6 is a side view of the loading dock of FIG. 4;

FIG. 7 is a side view of a trailer engaged with the locking device of FIG. 1;

FIG. 8 is a perspective view of a trailer positioned at the loading dock of FIG. 2;

FIG. 9 is a side view of the trailer and loading dock of FIG. 8; and

FIG. 10 is a plan view of the trailer and loading dock of FIG. 8.

### DESCRIPTION OF THE PREFERRED EMBODIMENTS

As used herein, spatial or directional terms, such as “top”, “bottom”, “left”, “right”, “up”, “down”, “front”, “rear”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification, figures, and claims are to be understood as being modified in all instances by the term “about”. Accordingly, unless indicated to the contrary, the numerical values set forth in the following specification, figures, and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. The dimensions shown on the attached drawings represent one embodiment of the invention and should not be considered as limiting. As used herein, the term “trailer” is not limited to conventional truck trailers but encompasses all types of shipping containers, such as but not limited to railway cars and shipping containers for air and sea transport.

The invention will now be described with reference to a conventional truck trailer and a conventional loading dock. However, it is to be understood that the invention is not limited to use with such conventional trailers or loading docks but could be utilized with any conventional shipping container and at any location at which a container is to be loaded and/or unloaded.

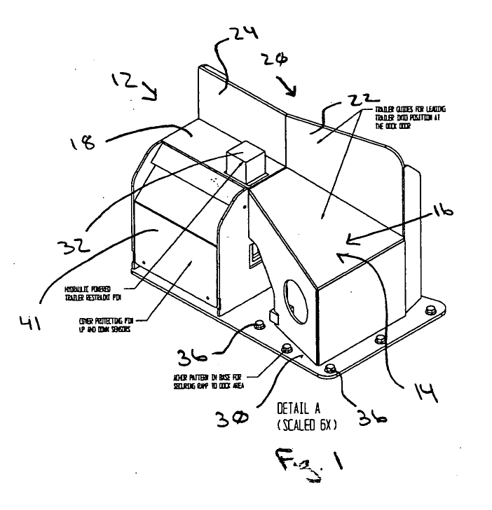

As shown in FIGS. 1-4, a locking and positioning system 10 of the invention includes one or more locking devices 12. The locking device 12 includes ramp 14 configured to contact a trailer skid as described in more detail below. The ramp 14 has an inclined first surface 16 leading to a positioning platform 18 which, in the illustrated embodiment, has a substantially horizontal positioning surface. The locking device 12 further includes a guide assembly 20 to laterally guide the trailer skid as described in more detail below. In the illustrated embodiment, the guide assembly 20 includes a first guide segment 22 adjacent to and extending upwardly from the ramp first surface 16 and a second guide segment 24 adjacent to and extending above the positioning platform 18. The first and second guide segments 22, 24 are angled with respect to each other to guide the trailer skid up the ramp 14 and onto the positioning platform 18, as described below. The ramp 14, positioning platform 18, and guide segments 22, 24 can be made of any suitable material, such as metal, for example steel, iron, or the like. The ramp 14 and positioning platform 18 can be carried on a base plate 30 and can be positioned at a desired height above the base plate 30 so as to position a trailer at a desired height, as described below. For example, the ramp 14 and positioning platform 18 can be carried on metal supports or ribs.

The locking device 12 further includes a movable locking member. In the exemplary illustrated embodiment, the locking member is a moveable locking pin 32 that can extend between a first position in which the pin 32 is retracted below the level of the surface of the positioning platform 18 to a second position (shown in FIG. 1) in which the pin 32 extends above the surface of the positioning platform 18. The pin 32 can be moved in any conventional manner, such as by electric, mechanical, or hydraulic motors. In the illustrated embodiment, the pin 32 is connected to a hydraulic actuator, such as a hydraulic piston 34, configured to raise and lower the pin 32.

The locking device 12 further includes fasteners 36, such as screws or bolts, configured to engage the base plate 30 such that the locking device 12 can be securely fastened at or near a desired location, such as a loading dock 40. The locking device 12 can further include a housing 41 to encase, at least partially, the hydraulic actuator 34.

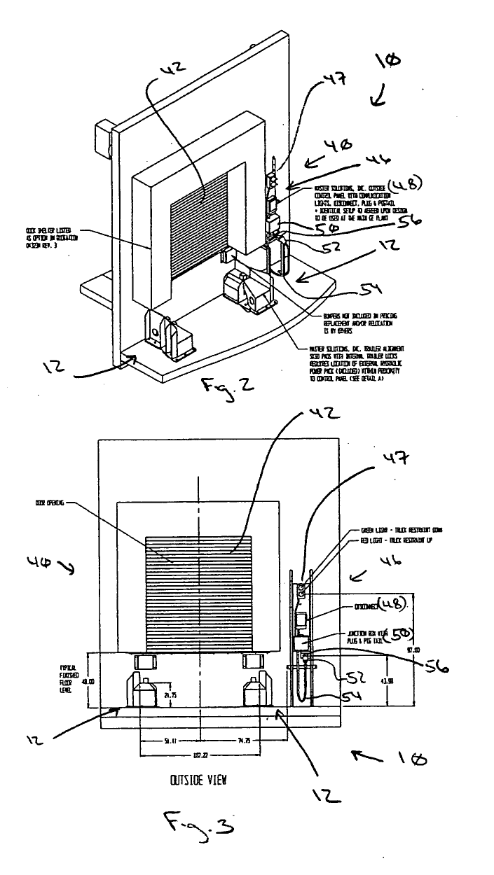

FIGS. 2 and 3 show locking devices 12 of the invention positioned in front of a conventional sliding door 42 at a loading dock 40. The locking devices 12 can be attached to the driveway or road surface in front of the door 42 by the fasteners 36. As is clear from FIGS. 2 and 3, the ramps 14 of the locking devices 12 face outwardly from the loading dock door 42. The guide first segments 22 are angled laterally outwardly and are configured to guide a trailer into proper alignment at the loading dock 40, as will be described in more detail below.

As also shown in FIGS. 2 and 3, the locking and positioning system 10 of the invention further includes a first or outer operating station 46. The outer operating station 46 includes signal devices indicating the status of the locking and positioning system 10 and/or controls to control various systems on the loading dock 40 and/or the trailer. In the illustrated embodiment, the outer operating station 46 includes drivers light signals 47, such as conventional red and green lights. When a light is green, this signals a driver that the locking and positioning system is disengaged and he can move the trailer. A red light signals that the locking and positioning system 10 is engaged and the trailer should not be moved. The outer operating station 46 further includes a disconnect switch 48 connected to a junction box 50. A plug 52 is connected to the junction box 50 by a cord 54. A receptacle 56 is configured to engage the plug 52 when the locking and positioning system 10 is not in use. The plug 52 can be a conventional multi-pin plug.

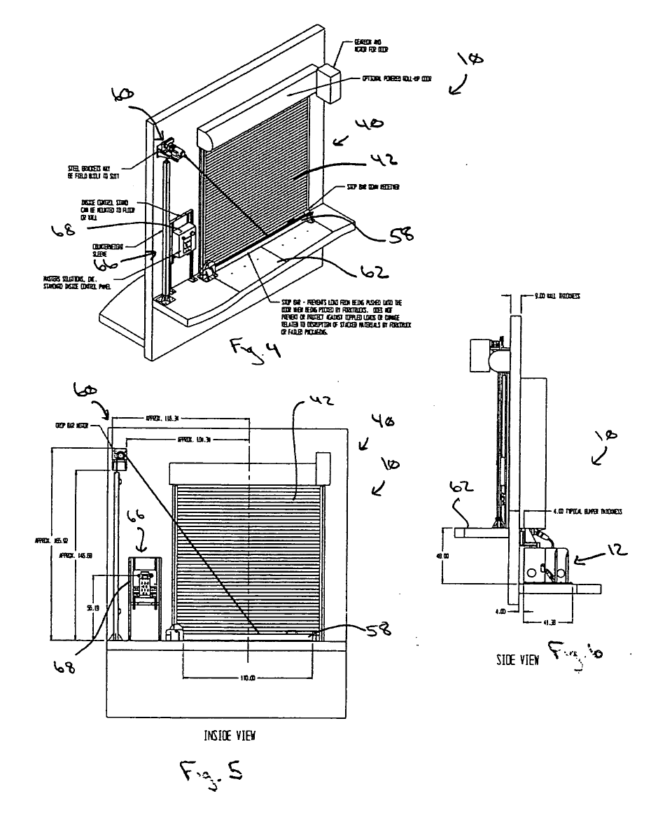

As shown in FIGS. 4 and 5, the exemplary loading dock 40 includes a conventional drop bar 58 which, in the illustrated embodiment, is pivotally connected to a motor and cable assembly 60 to raise and lower the drop bar 58. As will be appreciated by one skilled in the art, the drop bar 58 can be lowered when the door 42 is open in order to prevent personnel and/or equipment from exiting or entering the loading dock 40. The interior floor 62 of the loading dock 40 can include a conventional conveyor system (not shown) so that goods unloaded from the trailer at the loading dock 40 can be placed on the conveyor system and transported to a desired location or so that goods can be conveyed to the loading dock 40 for loading onto the trailer.

A second or inner operating station 66 is located inside the loading dock 40 near the door 42. The inner operating station 66 includes a control panel 68 having controls to operate one or more systems at the loading dock 40 or in a trailer positioned at the loading dock 40. For example, the controls can operate the main door 42, the drop bar 58, the loading dock conveyor (not shown), or a trailer conveyor (not shown) located in the trailer, just to name a few.

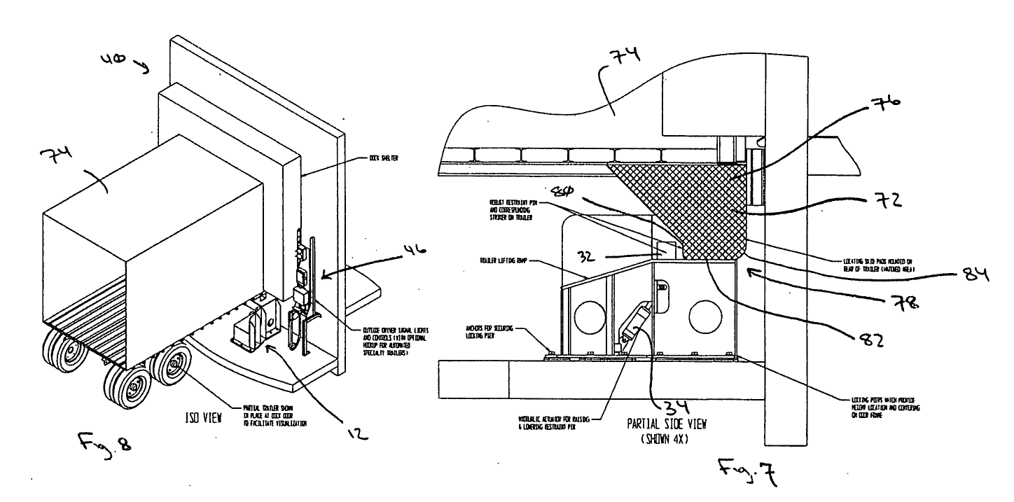

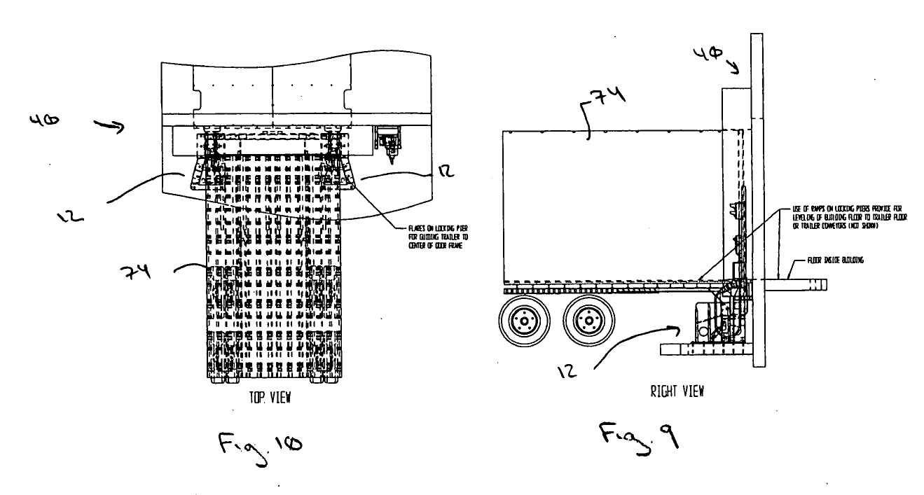

As will be appreciated from FIG. 7, at least one skid 72 is connected to a trailer 74. The skid 72 includes a base 76 connected to the trailer 74, such as to the underside frame of the trailer 74. The skid 72 has a locking portion 78 depending from the base 76. In the illustrated embodiment, the locking portion 78 is substantially rectangular and has a substantially planar, vertical locking face 80, a planar bottom 82, and a rounded or curved rear face 84.

Operation of the locking and positioning system 10 will now be described.

In an initial configuration, the locking and positioning system 10 is in a deactivated configuration, by which is meant that the locking pin 32 is in a lowered or retracted position and the plug 52 is plugged into the receptacle 56 at the outer operating station 46. In this configuration, the drivers light signal should be green. A driver approaches the loading dock 40 and begins backing the trailer 74 towards the loading dock 40. As will be appreciated from FIGS. 2, 7, and 8, as the trailer 74 is backed toward the loading dock 40, the skids 72, particularly the rear faces 84 of the skids 72, contact and begin riding up the ramps 14 of the locking devices 12. Should the trailer 74 not be correctly aligned (laterally) with the loading dock door 42, as the trailer 74 moves towards the door 42 the outer sides of the skids 72 contact the inner sides of the guide segments 22, 24 such that the trailer 74 is laterally guided into correct alignment by the guide segments 22, 24. With the locking pin 32 retracted, the skids 72 continue to slide up the ramps 14 and onto the positioning platform 18. The level or height of the positioning platform 18 can be selected such that when the bottoms 82 of the skids 72 rest on top of the positioning platform 18, the floor bed of the trailer 74 is at a desired height with respect to the loading dock 40. If the trailer 74 has a conventional conveyor system located therein, the height of the positioning platform 18 can be configured to align the rear of the trailer 74, i.e., the rear of the trailer conveyor, with a loading platform or a conveyor system located on the loading dock 40 to facilitate movement of goods from the trailer 74 onto the loading dock 40. Thus, as will be appreciated by one skilled in the art, the lateral and vertical alignment features of the locking and positioning system 10 are particularly advantageous for use with automated loading and unloading trailer systems to provide proper alignment and elevation control to match the trailer system, e.g., a trailer conveyor, with a building mounted conveyor system.

When the locking face 80 of the skid locking portion 78 is to the rear of the locking pin 32 position, rearward movement of the trailer 74 is stopped and the truck brake engaged. The driver can then exit the truck, walk to the outer operating station 46, remove the plug 52 from the receptacle 56, and plug the plug 52 into a receiver or socket on the trailer 74. The driver can then use the controls at the outer operating station 46 to engage, i.e., raise, the locking pin 32 to the position shown in FIG. 7. Thus, as will be appreciated by one skilled in the art, should the trailer 74 be moved forwardly or away from the loading dock 40, the locking face 80 of the skid 72 will contact the rear surface of the locking pin 32 to prevent the trailer 74 from being moved away from the loading dock 40. The plug 52 and cord 54 provide an electrical connection between the outer operating station 46 and the trailer 74, as will be described in more detail below. Additionally, the trailer 74 can be equipped with a computer or other electronic device having data, such as the amount and contents of the trailer 74, to update a computer system at the loading dock 40 via the plug 52 and cord 54 as to what goods are being unloaded from the trailer 74.

With the trailer 74 locked in place on the locking devices 12 and the plug 52 connected to the trailer 74, the driver can then enter the loading dock 40, such as through a conventional side door, and into the interior of the loading dock 40. Once inside, the driver can use the inner operating station 66 to open the main door 42 and raise the drop bar 58. Additionally, the inner operating station 66 can be electronically connected through the outer operating station 46 and the plug 52 and cord 54 to operating systems on the trailer 74. For example, should the trailer 74 include a conventional conveyor system, the inner operating station 66 can have controls to operate the trailer conveyor system. Thus, with the main door 42 and drop bar 58 open, the driver can activate the trailer conveyor system through the inner operating station 66 to begin moving goods out of the trailer 74 and onto the loading dock 40, such as onto a conventional conveyor system on the loading dock 40. Alternatively, goods from the loading dock 40 can be loaded into the trailer 74.

When the goods are unloaded from (or loaded onto) the trailer 74, the driver can lower the main door 42 and/or drop bar 58 and exit the loading dock 40 through the side door. The driver can then disengage (i.e., lower) the locking pin 32, disconnect the plug 52 from the trailer 74, and place the plug 52 in the exterior receptacle 56. With the locking pin 32 disengaged and the plug 52 in the receptacle 56, the driver light signal 47 should be green, which means that the trailer 74 can be driven away from the loading dock 40.

Thus, the present invention provides a system for not only locking a trailer in place at a desired location but also for horizontally and laterally aligning the trailer to facilitate loading and unloading.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A trailer locking and positioning system, comprising:
at least one locking device, the locking device including a movable locking member and aligning means for laterally and/or vertically aligning the trailer.

2. The system according to claim 1, wherein the locking member is a locking pin movable from a first (unlocked) position to a second (locked) position.

3. The system according to claim 1, wherein the aligning means includes a ramp leading to a positioning platform.

4. The system according to claim 1, wherein the aligning means includes guide segments configured to laterally align a trailer.

5. The system according to claim 1, wherein the locking device comprises:
a ramp leading to a positioning platform, the positioning platform configured to maintain a trailer at a desired height;
at least one guide segment configured to laterally align the trailer on the locking device; and
a locking pin movable from a first position below the positioning platform to a second position above the positioning platform.

6. The system according to claim 5, including a hydraulic piston connected to the pin.

7. The system according to claim 1, including an outer operating station, comprising:
a plug and cord;
a receptacle, wherein the plug is configured to releasably engage the receptacle; and
controls for operating one or more systems of a loading dock and/or a trailer.

8. The system according to claim 7, wherein the plug is configured to engage a socket on a trailer.

9. The system according to claim 7, wherein the outer operating station includes one or more driver signal lights.

10. The system according to claim 1, further including an inner operating station.

11. The system according to claim 10, wherein the inner operating station includes controls for operating one or more systems at a loading dock and/or a trailer.

12. The system according to claim 1, wherein the locking and positioning system includes a skid connectable with a trailer, the skid comprising a base connectable to a trailer and a locking portion configured to engage the locking device.

13. The system according to claim 12, wherein the locking portion comprises a locking face, a bottom, and a curved rear face.

14. A locking and positioning system, comprising:
a skid connectable with a trailer, the skid including a locking portion having a locking face;
a locking device including a ramp leading to a positioning platform, the locking device further including at least one guide segment, and a pin moveable between a locked position and an unlocked position;
an outer operating station comprising a plug, a cord, and a receptacle, wherein the plug is configured to releasably engage the receptacle; and
an inner operating station comprising controls for operating one or more systems at a loading dock and/or on a trailer.
